(19) United States
(12) Patent Application Publication
(10) Pub. No.: US 2010/0132881 A1
(43) Pub. Date: Jun. 3, 2010

(54) ARTICLE WITH OBVERSE AND REVERSE SIDE PRINTING

(76) Inventor: Michael H. Gaughan, Montgomery, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/625,015

(22) Filed: Nov. 24, 2009

Related U.S. Application Data
(60) Provisional application No. 61/118,214, filed on Nov. 26, 2008.

(51) Int. Cl. B32B 38/10; B32B 33/00; B32B 38/14

(52) U.S. Cl. 156/249; 428/40.1; 156/277; 156/247

(57) ABSTRACT

The application discloses multiple layered structures having releasable print layers to provide reverse side printing. The printing is formed of a mirror image print to provide the reverse side printing following release from an obverse side of a base structure. In illustrated embodiments, the application discloses multiple print layers including one or more non-mirror image print layers and the minor image print layer to provide reverse and obverse side print using a multiple layered structure or construction.

### BRIEF DESCRIPTION OF THE DRAWINGS

FIG. 1 is a schematic illustration of an embodiment of a multiple layered structure or self-adhesive label having multiple print layers for obverse and reverse side printing.

FIG. 2 is a schematic illustration of the embodiment of the multiple layered structure or self-adhesive label of FIG. 1 including a first print layer on the obverse side and second print layer on the reverse side of the multi-layered structure or label.

FIG. 3 illustrates an embodiment of a multiple layered structure or label of the type illustrated in FIGS. 1-2 wrappable about a bottle or container.

FIG. 4 illustrates the multiple layered structure or label illustrated in FIG. 3 unwrapped from the bottle or container and including obverse and reverse side printing.

FIG. 5 is a cross-sectional view of an embodiment of a wrappable multiple layered structure or label of the type illustrated in FIGS. 3-4.

FIG. 6 illustrates the embodiment of the multiple layered structure or label illustrated in FIG. 5 unwrapped to provide reverse side printing.

FIG. 7 is a cross-sectional view of an embodiment of a multiple layered structure or label including multiple print layers of the type illustrated in FIG. 1.

FIG. 8 is a flow chart illustrating process steps for forming a multiple layered structure or label including multiple print layers for obverse and reverse side printing.

FIG. 9 is a schematic illustration of multiple articles or labels of the type previously described formed along a continuous backing or liner.

FIG. 10 illustrates an embodiment of a multiple layered structure including multiple base structures connected along a seam to form multiple pages.

FIG. 11 illustrates the embodiment of the multiple layered structure of FIG. 10 where the multiple base structures form multiple pages having obverse and reverse side printing.

FIG. 12 is a cross-sectional view of an embodiment of the multi-layered structure having multiple pages including obverse and reverse side printing of the type illustrated in FIGS. 10-11.

FIG. 13 is a cross-sectional view of an embodiment of the multiple layered structure of FIG. 12 shown with the pages separated to view the obverse side of the first page and the reverse side of the second page.

FIG. 14 is a detailed illustration of a tab portion for separating pages of the multi-layered structure of FIG. 10.

FIG. 15 is a cross-sectional view of the tab portion of FIG. 14.

FIG. 16 is a flow chart illustrating process steps for forming a multiple layered structure or article including multiple print layers for obverse and reverse side printing.

### DETAILED DESCRIPTION OF ILLUSTRATIVE EMBODIMENTS

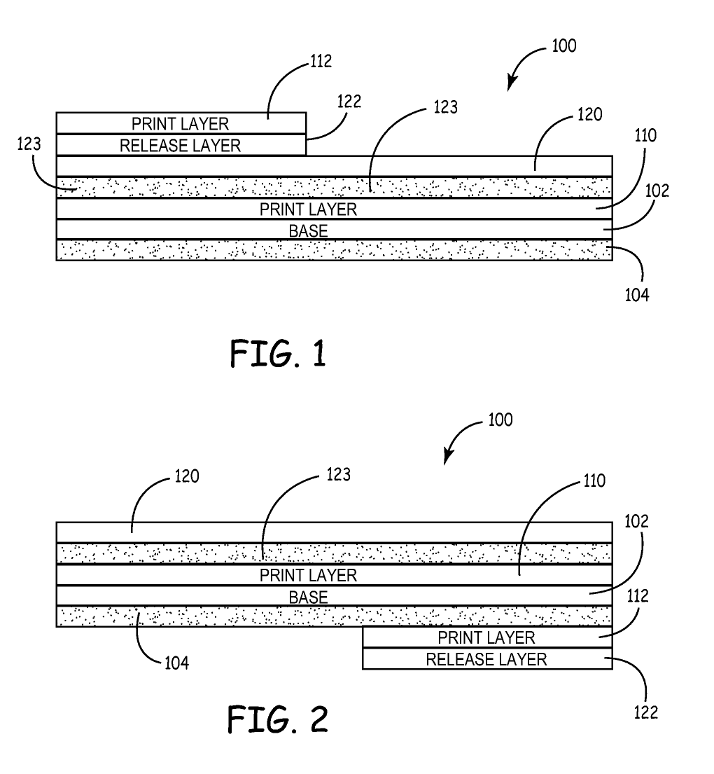

FIGS. 1-2 schematically illustrates an embodiment of a multiple layered structure 100 including obverse side and reverse side printing. As shown in FIG. 1, the label 100 includes a base structure having one or more layers including a base layer 102. An adhesive layer 104 is provided on a reverse side of the base structure to form a label. The multiple layered structure 100 includes first and second print layers 110, 112 on the obverse side of the base structure or base layer 102. The first and second print layers 110, 112 are separated by a protective layer 120 and a releasable layer 122. As shown an adhesive layer 123 connects the protective layer 120 to the base layer 102 of the base structure. The releasable layer 122 is designed to separate from the protective layer 120 upon the application of force to transfer the second print layer 112 and release layer 122 to the reverse side of the base structure by adhering to adhesive layer 104 as illustrated in FIG. 2.

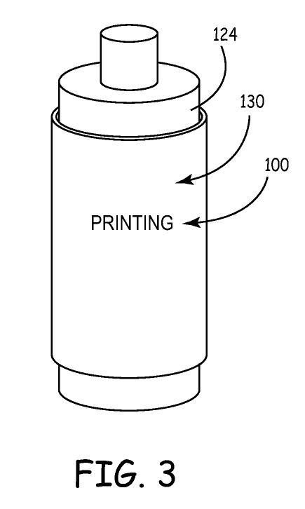

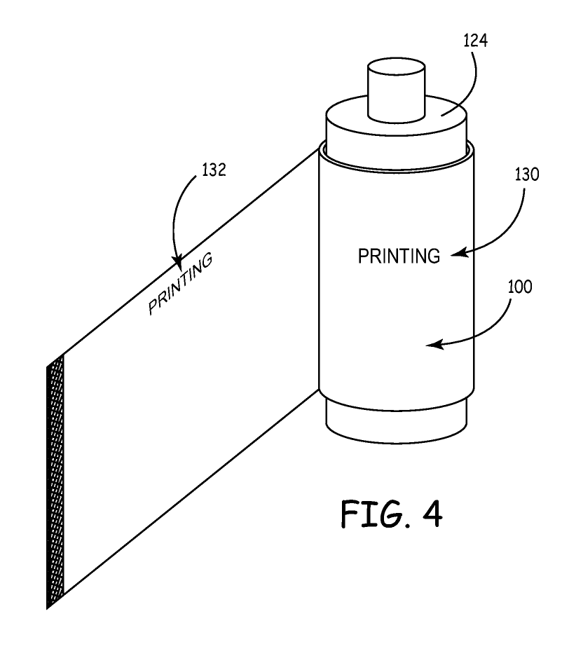

In the illustrated embodiment shown in FIGS. 3-4, the multiple layered structure 100 forms a label having a length, which can be wrapped about an outer circumference of a bottle or other container 124 as shown in FIG. 3. In the wrapped configuration, the reverse side of the label or base structure faces inwardly toward the bottle or container 124 to adhere to the container and the obverse side faces outwardly. The obverse side of the label includes printing 130 formed by the first print layer 110 as shown in FIGS. 1-2. As shown, the length of the multiple layered structure or label provides a portion that overlaps an inner portion. When the overlapping portion is unwrapped as shown in FIG. 4, the reverse side of the multiple layered structure includes printing 132 formed by the second print layer 112 and releasable layer 122 (shown in FIGS. 1-2), which transfers to the reverse side of the base structure or base layer 102 by adhering to adhesive layer 104 when the multiple layered structure or label 100 is unwrapped.

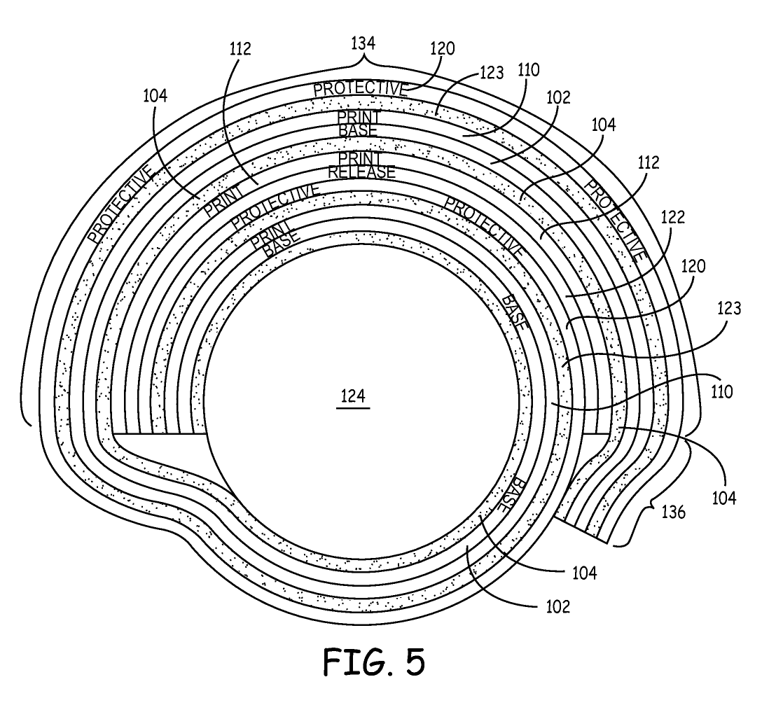

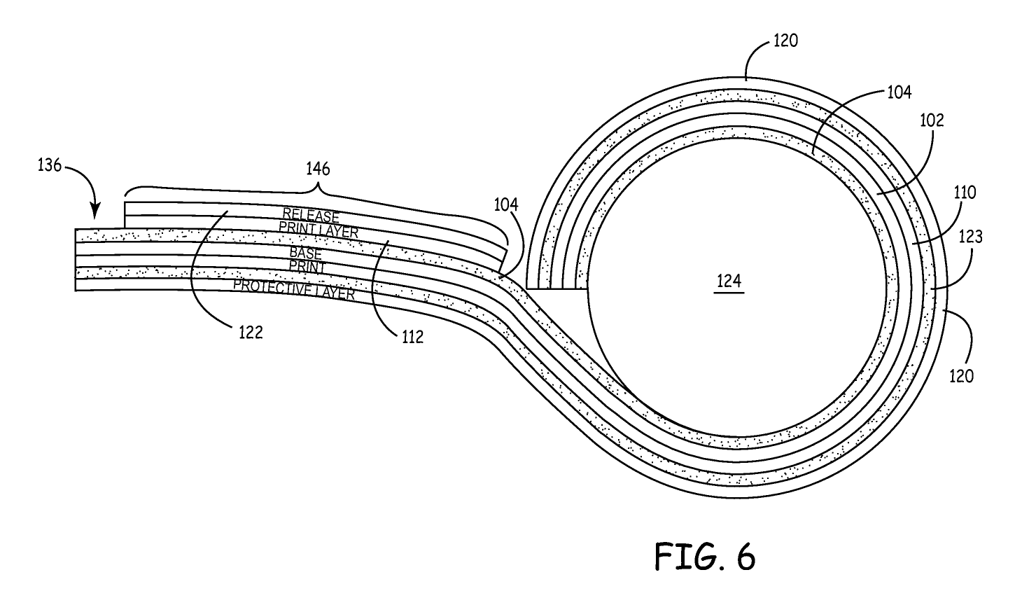

FIGS. 5-6 illustrate in more detail an embodiment of a multiple layered structure or label wrappable about a bottle or container 124, where like numbers are used to refer to like parts in the previous FIGS. As shown in FIG. 5, in the wrapped configuration, an overlapping portion 134 of the adhesive layer 104 on the reverse side of the base structure or base layer 102 adheres to the print layer 112 and release layer 122, on the obverse side of the multiple layered structure or label. When unwrapped, as illustrated in FIG. 6, print layer 112 and releasable layer 122 remain adhered to adhesive layer 104 and separate from protective layer 120 to transfer the second print layer 112 to the obverse side of the multiple layered structure or label (adjacent adhesive layer 104). As shown, releasable layer 122 and second print layer 112 separate from protective layer 120 to form the reverse side printing 132 (FIG. 4). Following separation, releasable layer 122 covers adhesive layer 104 to deaden the adhesive along the overlapping portion of the multiple layered structure or label. In the illustrated embodiment, a small edge strip 136 of the label does not include releasable layer 122 to provide an adhesive strip (portion of adhesive layer 104) which bonds to protective layer 120 to rewrap and resecure or seal the multiple layered structure or label in the wrapped configuration.

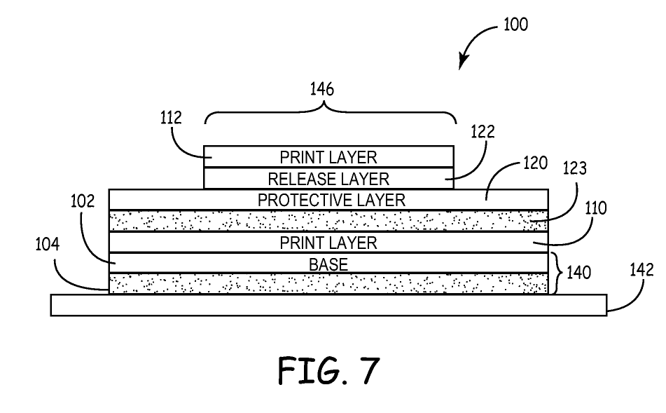

FIG. 7 is a detailed illustration of an embodiment of the multiple layered structure or self adhesive label as described in FIGS. 1-6. As shown, the multiple layered structure or label 100 includes the base structure having a pressure sensitive adhesive layer on the reverse side of the base structure or base layer 102. In an illustrated embodiment, the base layer 102 and adhesive layer 104 are provided as a coated self-adhesive label 140. An example coated self adhesive label 140 is a top coated label, such as for example, a 2.6 mil top coated white Label-Lyte™ (026TL) available from Green Bay Packaging Inc. of Greenbay, Wis. As shown, the adhesive layer 104 of the coated self adhesive label 140 is covered with a backing or liner 142, for example a silicone coated liner or backing, which is peeled from the multiple layered structure or label and removed to expose adhesive 104. Various liners or backings 142 can be used depending upon the particular adhesive as will be appreciated by those skilled in the art.

As shown in FIG. 7, the print layer 112 is printed on the obverse side of the multiple layered structure or label on top of release layer 122. Print layer 110 is printed on the base structure 102 and is covered with a clear or transparent protective layer 120 so that the first print layer 110 is visible. In the embodiment shown, the protective layer 120 and adhesive layer 123 are provided as a clear polypropylene lamination tape. The polypropylene lamination tape includes a biaxially orientated polypropylene material which forms the protective layer 120 and an acrylic adhesive which forms the adhesive layer 123. An illustrative polypropylene lamination tape is available from Sekisui TA Industries, Inc. of Brea, Calif.

Releasable layer 122 is deposited along a releasable portion 146 of the label and the second print layer 112 is printed on the release layer 122 as shown. In an illustrated embodiment, the releasable layer 122 is a clear coat UV varnish having sufficient thickness so that the print layer 112 adheres thereto. The protective layer 120 also has sufficient adhesion so that the print layer 112 and releasable layer 122 remain on the label and do not wipe off prior to separation. The first and second print layers 110, 112 can be printed with known printing inks as will be appreciated by those skilled in the art.

As previously illustrated, in the wrapped configuration shown in FIG. 5, the adhesive layer 104 on the reverse side of the base structure or base layer 102 adheres to the releaseable layer 122 and print layer 112 on the obverse side of the base layer or structure. The adhesion force holding the adhesive layer 104 to releasable layer 122 is stronger than the adhesion between releasable layer 122 and protective layer 120 such that upon the application of force, the multiple layered structure or label separates along layers 120, 122. Upon separation, the second print layer 112 and releasable layer 122 remain adhered to the adhesive layer 104 to transfer the second print layer 112 to the reverse side and deaden the adhesive 104 along the releasable portion 146 of the reverse side of the multiple layered structure or label. The released print layer 112 provides the reverse side printing 132 as previously described and illustrated in FIGS. 4 and 6.

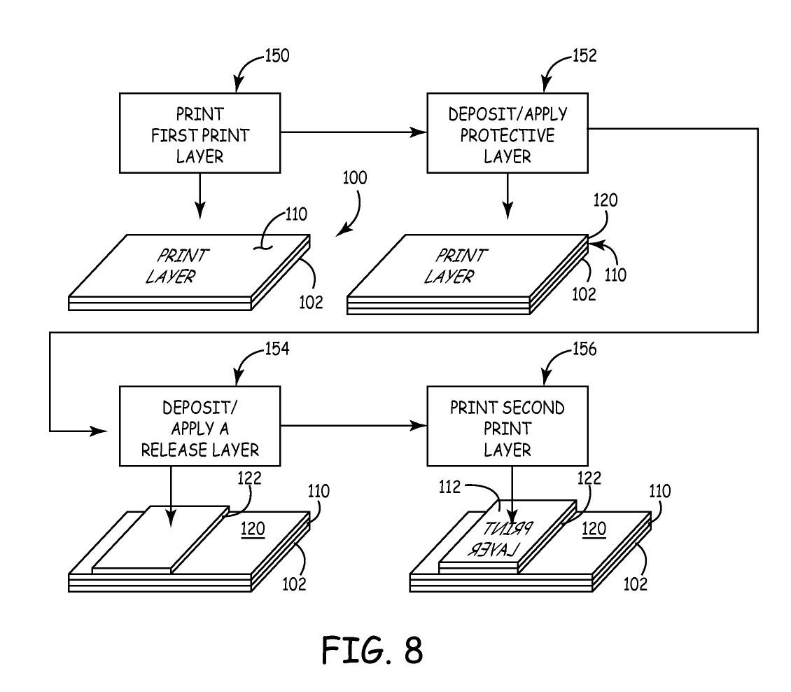

FIG. 8 schematically illustrates process steps for forming the multiple layered structure or label having obverse and reverse side printing as illustrated in FIGS. 1-7. As shown in step 150, an obverse side of a self adhesive label or base layer 102 is printed with the first print layer 110. The print layer include non-minor image print to form standard printing or text. Thereafter in step 152, protective layer 120 is deposited over the first print layer 110. As shown, the protective layer 120 is clear or transparent so that the print layer 110 is visible through the protective layer 120. In step 154, a releasable layer 122 is deposited over a portion of protective layer 120 and in step 156, a second print layer 112 is deposited on the releasable layer 122 to the provide the reverse printing 132 as previously described. The second print layer 112 include minor image print so that when the second print layer 112 is released, the printing 132 on the reverse side appears as standard printing or text (e.g., non-mirror image printing).

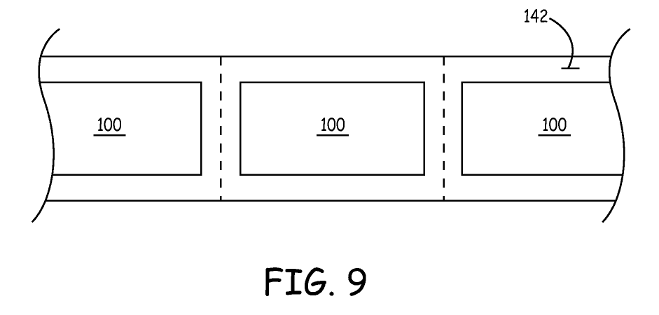

The illustrative steps of FIG. 8 are implemented using known in-line printing processes to sequentially print a plurality of multiple layer labels or structures 100 as illustrated in FIG. 9. As shown, the plurality of multiple layered labels 100 are formed on a continuous backing or liner 142. The backing or liner 142 is cut or perforated to separate adjacent labels.

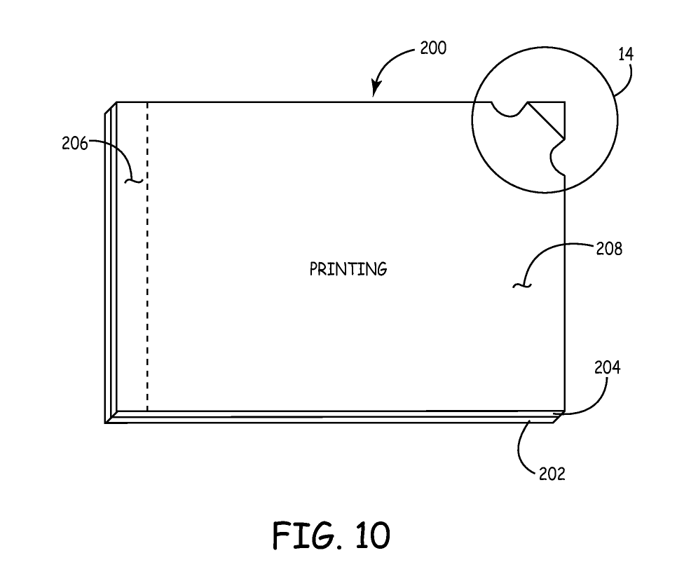

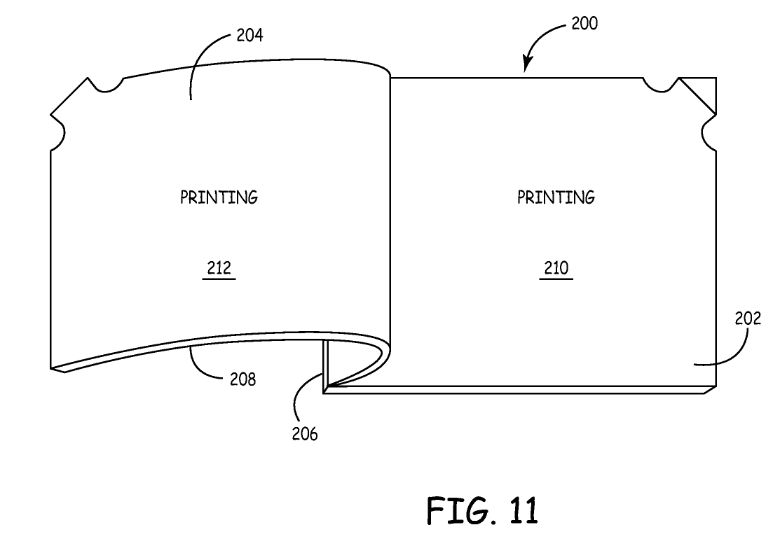

FIGS. 10-11 schematically illustrate another embodiment of a pressure sensitive adhesive label or multiple layered structure 200 including obverse side and reverse side printing. As comparatively shown in FIGS. 10-11, the label or structure 200 includes multiple first and second pages 202, 204 coupled along a seam 206. As shown in FIG. 10, in a closed position, the label or multiple layered structure 200 includes printing 208 on an obverse side of the second page 204.

In FIG. 11, the first and second pages 202, 204 are opened and separated. As shown, in FIG. 11, the first and second pages 202, 204 are opened or separated to view the obverse side of page 202 and the reverse side of page 204. In the illustrated embodiment shown in FIG. 11, the obverse side of the first page 202 and reverse side of the second page 204 include printing 210, 212, respectively as shown. When the pages 202, 204 are first opened or separated, printing on the first page 202 transfers to the second page 204 to form the reverse side printing 212 on the second page 204. In particular, when the pages are first opened, a print layer (not shown in FIG. 11) from the obverse side of the first page 202 transfers to the reverse side of second page 204 to provide the printing 212 on the reverse side of page 204 as previously described.

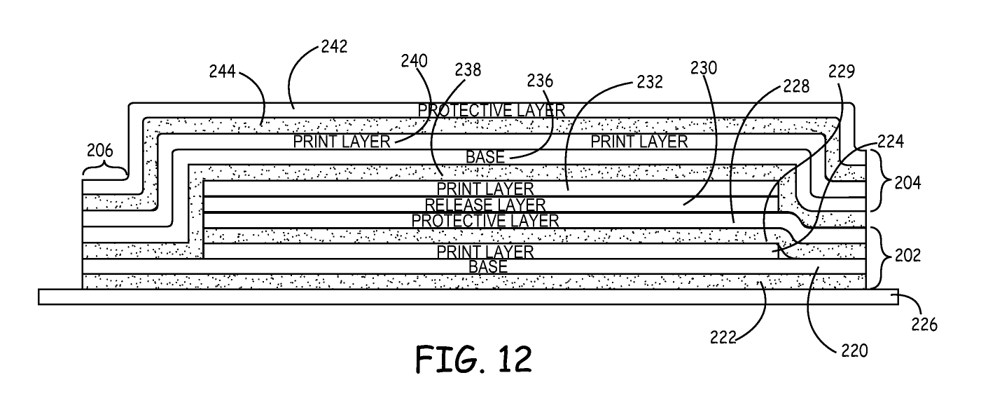

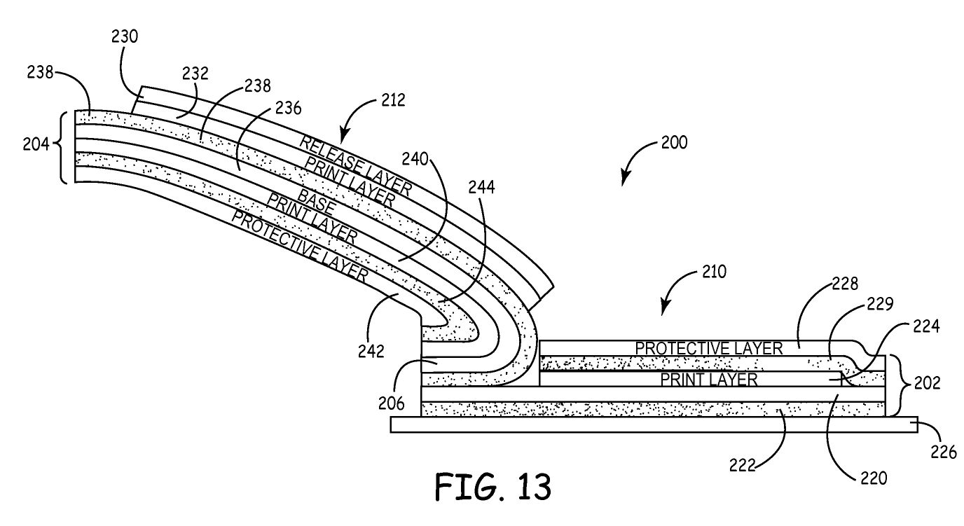

FIGS. 12-13 are cross-sectional views of an embodiment of the label or multiple layered structure 200 illustrated in FIGS. 10-11 including first and second separable pages 202, 204. As shown, the first page 202 includes a first base structure having a pressure sensitive adhesive layer 222 on the reverse side of a base layer 220 and a print layer 224 on the obverse side of the base structure. As shown, a releasable backing or liner 226 covers the adhesive layer 222 prior to use. The first print layer 224 is covered with a protective layer 228, connected to the print layer 224 and base layer 220 through adhesive layer 229. In an illustrated embodiment, the protective layer 228 and adhesive layer 229 are provided as a clear polypropylene lamination tape as previously described. As shown, a releasable layer 230 is deposited on the protective layer 228 and a second print layer 232 is deposited on the releasable layer 230 to provide the reverse side printing for the second page 204.

The second page 204 includes a second base structure. In the illustrated embodiment, the second base structure includes a second base layer 236 and adhesive layer 238 on a reverse side thereof. The second base structure is attached to the first base structure (via adhesive layer 238) to form the seam 206 connecting the first and second pages 202, 204. The bond between the adhesive layer 238 and the base layer 220 along seam 206 is sufficient so that pages 202, 204 are not easily separated. As shown, a third print layer 240 is applied to the second base layer 236 or structure to form the obverse side printing 208 on the second page as illustrated in FIG. 10. In the illustrated embodiment, another protective layer 242 is deposited on the third print layer 240 and adhered to print layer 240 and base layer 236 through adhesive layer 244.

When pages 202, 204 are closed (as shown in FIG. 12), the adhesive layer 238 adheres to print layer 232 and releasable layer 230, which separates from protective layer 228 when opened as illustrated in FIG. 13 to form the reverse side printing 212 for the second page 204. As shown in FIGS. 12-13, the adhesive layer 238 on the reverse side of page 204 adheres to the protective layer 228 along a border portion of the label or structure 200 to attach the second page 204 to the first page 202. The adhesion between the adhesive layer 238 and protective or polypropylene layer 228 allows page 204 to peel back from page 202 upon application of force to separate the first and second pages 202, 204.

Upon continued application of force, the releasable layer 230 separates from protective layer 228 so that print layer 232 transfers to the reverse side of page 204. In particular, the adhesion force holding the adhesive layer 238 to releasable layer 230 is stronger than the adhesion between releasable layer 230 and protective layer 228 such that upon the application of force, the label separates along layers 228, 230. Upon separation, the second print layer 232 and releasable layer 230 remain adhered to the adhesive layer 238 to transfer the second print layer 232 to the reverse side of the second page 204 and deaden the adhesive along a portion of the reverse side of the page 204 as previously described.

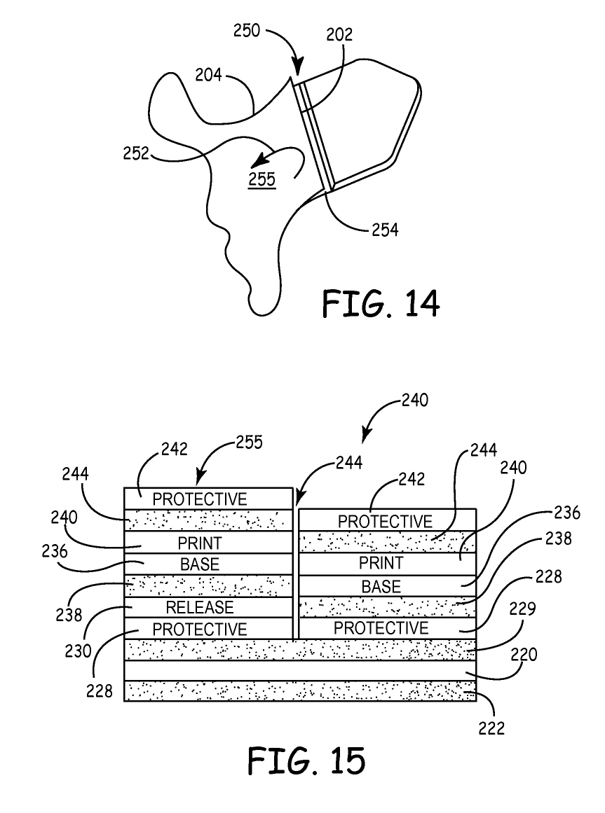

As illustrated in detail in FIG. 14, pages 202, 204 are separated at bendable tab 250. As shown, the first and second pages are cut at a corner to form the bendable tab 250 to peel back the second page 204 from the first page 202 as illustrated by arrow 252. As shown, the second page 204 is cut to form two segments separable along the cut line 254. The tab 250 is bent along the cut line 254 to peel back a first segment 255 of the second page 204 to separate the second page 204 from the first page 202. As shown, in FIG. 15, the releasable layer 230 is deposited along the first segment of the tab 250 to form separable portions that separates along the protective layer 228 and releasable layer 230. Separation along layers 228, 230 deadens the adhesive layer 238 as previously described. In the other segment of the tab 250, the base structure is adhered to the second base structure without the interposed releasable layer 230 as shown.

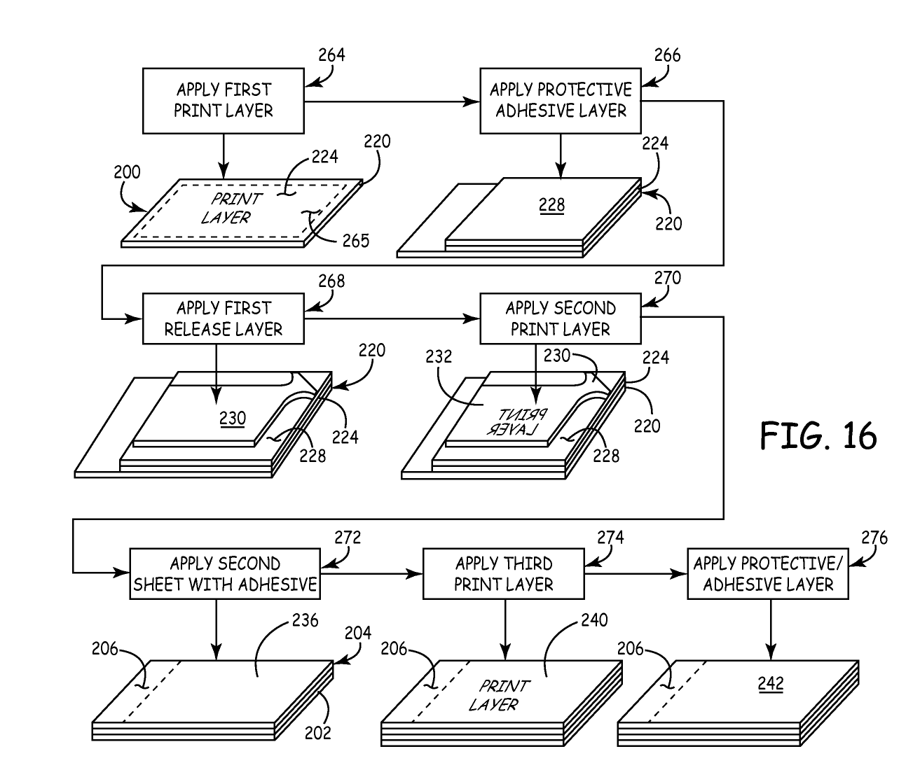

FIG. 16 schematically illustrates process steps for forming the label or structure having obverse and reverse side printing of the type illustrated in FIGS. 10-15. As shown in FIG. 16 in step 264, an obverse side of a base structure is printed with the first print layer 224. The print layer 224 is printed in an area spaced from a border of the label to form a print area 265 and separate border area as shown. As shown in step 266, protective layer 228 is deposited over the first print layer 224. As previously described, the protective layer 228 is a polypropylene lamination tape with adhesive. As shown, an edge of the protective layer 228 is spaced from an edge of the base layer(s) to form the seam 206 as will be described.

In step 268, the releasable layer 230 is deposited on a portion of protective layer 228. As previously described, the releasable layer 230 is a UV varnish having sufficient thickness to adhere to protective layer 228. As shown, a perimeter of the releasable layer 230 is spaced inwardly of the protective layer 228 to provide the border region along sides of the label or base structure 200 to reseal page 204 to page 202 via adhesive layer 238. As shown, the releasable layer 230 is also patterned along a corner of the label or article to form the tab 250 as previously described. As shown, in step 270, the second print layer 232 is deposited on the releasable layer 230 so that perimeter edges of the print layer 232 align with edges of the releasable layer 230 so that the printed texts does not extend into the border region.

As shown, the second print layer 232 is a minor image print or text so that when the print layer 232 is transferred to the reverse side of page 204, the printing appears as standard text or graphics. Thereafter, in step 272 the base layer 236 and adhesive layer 238 of the second page 204 is applied on top of the base layer 220 of the first page so that the adhesive layer 238 of the second page 204 adheres to the first page 202 along seam 206. Additionally as shown in step 274, a third print layer 240 is deposited on the second page or second base structure and a protective layer 242 and adhesive layer 244 are deposited on top of the print layer 240 of the second base structure as illustrated in step 276. Print layers 224 and 240 include non-mirror image print so that the text or graphics appears as standard text or graphics. Although multiple non-mirror image print layers are shown, application is not limited to the multiple layered structure including one or both of the non-minor image print layers shown.

As previously described, the third print layer 240 provides printing 208 on the obverse side of the second page 204. When the pages are separated, the second print layer 232 and releasable layer 230 are transferred to the reverse side of the second page 204. In particular, as described, upon the application of force, the adhesive force of layer 238 (as illustrated in FIGS. 12-13) causes separation of the releasable layer 230 from protective layer 228 to transfer the second print layer 232 and deaden the adhesive layer 238. In the border region, the adhesive layer 238 of the second base structure on the reverse side of 204 interfaces with protective layer 228 so that page 204 has sufficient adhesion to reseal page 204 to page 202 along the border region.

Although the present invention has been described with reference to preferred embodiments, workers skilled in the art will recognize that changes may be made in form and detail without departing from the spirit and scope of the invention.

What is claimed is:

1. A multiple layered structure comprising:
a base structure having an obverse side and a reverse side and including one or more layers including a protective layer on the obverse side;
a releasable printed portion on the obverse side of the base structure and the releasable printed portion including a print layer and a releasable layer adhered to the protective layer on the obverse side of the base structure; and
an adhesive layer disposed relative to the base structure, and a relative adhesion between the releasable layer and the protective layer and the adhesive layer and the releasable layer is configured to allow the releasable printed portion to separate from the obverse side of the base structure.

2. The multiple layered structure of claim 1 wherein the print layer of the releasable printed portion includes minor image print that appears as non-mirror image printing after the releasable printed portion separates from the obverse side of base structure.

3. The multiple layered structure of claim 2 wherein the base structure includes a print layer including non-mirror image print on the obverse side of the base structure.

4. The multiple layered structure of claim 3 wherein the protective layer is formed of a transparent or clear layer having an adhesive on the reverse side of the transparent or clear layer and the transparent or clear layer is deposited on the non-mirror image print layer so that the non-mirror image print is visible.

5. The multiple layered structure of claim 1 wherein the adhesive layer is on the reverse side of the base structure and the releasable layer separates from the protective layer to adhere to the adhesive layer on the reverse side of the base structure.

6. The multiple layered structure of claim 5 wherein the one or more layers of the base structure are relatively flexible and wrappable about a container or object and a length of the base structure is sized so that when wrapped the adhesive layer on the reverse side of the base structure overlaps a portion of the base structure to adhere to the releasable printed portion to separate the releasable print layer from the obverse side of the base structure to transfer the print layer to the reverse side of the base structure.

7. The multiple layered structure of claim 6 wherein the separation of the releasable print portion deadens adhesive of the adhesive layer and the releasable print portion is spaced from one or more edges of the base structure to provide an adhesive strip that adheres to the protective layer on a wrapped obverse side of the base structure to selectively wrap and unwrap the multiple layered structure from the container or object.

8. The multiple layered structure of claim 1 where the base structure forms a first base structure and an adhesive layer on a reverse side of a second base structure connects the first and second base structures and the releasable printed portion adheres to the adhesive layer on the reverse side of the second base structure to transfer the print layer of releasable printed portion from the obverse side of the first base structure to the reverse side of the second base structure when the second base structure is separated from the first base structure.

9. The multiple layered structure of claim 8 wherein the first and second base structures are connected along a seam.

10. The multiple layered structure of claim 9 wherein the adhesive layer on the reverse side of the second base structure interfaces with the first base structure to form the seam adhesively connecting the first and second base structures.

11. The multiple layered structure of claim 8 wherein the releasable printed portion is spaced from one or more border portions of the first base structure and the adhesive layer on the second base structure interfaces with the protective layer along the one or border portions of the first base structure to releasably connect the first base structure relative to the second base structure to selectively seal and unseal the first and second base structures along the one or more border portions.

12. The multiple layered structure of claim 8 wherein the print layer of the releasable printed portion includes minor-image print and one or both of the first and second base structures include a non-mirror image print layer including non-minor image print on the obverse side of one or both of the first and second base structures.

13. The multiple layered structure of claim 8 and comprising a tab configured to separate the first and second base structures and the tab including a first portion having the first and second base structures adhesively connected and a second separable portion where the first and second base structures separate along the releasable layer to unseal the first and second base structures.

14. A method comprising:
applying a releasable layer on a protective layer on an obverse side of a base structure having one or more layers;
printing a minor image print layer after applying the releasable layer; and
applying an adhesive layer to adhere to the releasable layer to separate the releasable layer and the mirror image print layer from the obverse side of the base structure.

15. The method of claim 14 wherein the step of applying the adhesive layer comprises:
applying the adhesive layer to the reverse side of the base structure or on the releasable layer.

16. The method of claim 14 and comprises:
printing a non-mirror image print layer on the obverse side of the base structure prior to printing the minor image print layer.

17. The method of claim 14 wherein the step of applying the adhesive layer comprises
applying the adhesive layer on the releasable layer;
applying a second base structure including one or more base layers on the adhesive layer; and
forming a seam connecting the first and second base structures.

18. A method comprising:
applying force to separate minor image print on a obverse side of a base structure; and
transferring the minor image print to the reverse side of the base structure or to the reverse side of another base structure connected to the base structure.

19. The method of claim 18 wherein the minor image print is formed on a multiple layered structure including the base structure and comprising:
wrapping the multiple layered structure about a cylindrical body or article so that a portion of the wrapped multiple layered structure adheres to the cylindrical body or article and a portion of the multiple layered structure having the minor image print overlaps the obverse side of the base structure; and
unwrapping the overlapping portion of the multiple layered structure to separate the minor image print from the obverse side of the base structure and transfer the minor image print to the reverse side of the base structure.

20. The method of claim 19 wherein the multiple layered structure includes an adhesive layer on the reverse side of the base structure and comprising:
removing a lining or backing from the adhesive layer prior to wrapping the multiple layered structure about the cylindrical body or article.
